(19) United States
(12) Patent Application Publication
(10) Pub. No.: US 2008/0270949 A1
(43) Pub. Date: Oct. 30, 2008

(54) Methods and Systems for Navigation and Selection of Items within User Interfaces with a Segmented Cursor

(76) Inventor: Younger L. Liang, Taipei (TW)

Correspondence Address: WILSON SONSINI GOODRICH & ROSATI, 650 PAGE MILL ROAD, PALO ALTO, CA, 94304-1050, US

(21) Appl. No.: 11/740,239

(22) Filed: Apr. 25, 2007

(51) Int. Cl. G06F 3/048

(52) U.S. Cl. 715/859

(57) ABSTRACT

Methods and systems for navigating and selecting items within a user interface. Various groupings of items may be displayed and selected within the user interfaces which may further include a graphical rounded positioning locator. The locator can be designed to resemble a compass with indicia to provide the user with a relative location and bearings within an arrangement of items. The indicia can include rounded lettering having a curvature that may additionally indicate optional rotational or wraparound menu features. Furthermore, user interfaces are provided which may include segmented cursors or pointers with multiple select keys that provide a plurality of items to choose from within the display rather than just one available item or selection. Items can be any kind of alphabetical and/or numerical information such as contact information with names and addresses, or any other kind of data including television programming within a viewing guide or other data displayed within documents or spreadsheets.

### FIELD OF INVENTION

The invention relates to user interface navigation and selection of items within a display. More particularly, the invention relates to systems and methods for navigating and selecting items within user interfaces having segmented cursors that allow for multiple selections.

### SUMMARY OF INVENTION

The invention resolves many of the difficulties in navigating through and selecting items within functional displays containing significant amounts of information. The methods and systems provided in accordance with the invention allow user viewing and selection of information that may be arranged or organized within a hierarchical menu. The selection of items within user interfaces herein can be accomplished through limited input methods or keys within many devices such as portable or mobile devices such as remote controls for electronic equipment such as TVs or cable boxes, portable media players, handheld devices, personal digital assistants (PDAs) and mobile telephones or communications devices.

For example, a plurality of items can be organized and displayed to a user within a table as shown below containing thirty-six (36) items.

| | 1 | 2 | 3 | 4 | 5 | 6 |
|---|---|---|---|---|---|---|
| A | A-1 | A-2 | A-3 | A-4 | A-5 | A-6 |
| B | B-1 | B-2 | B-3 | B-4 | B-5 | B-6 |
| C | C-1 | C-2 | C-3 | C-4 | C-5 | C-6 |
| D | D-1 | D-2 | D-3 | D-4 | D-5 | D-6 |
| E | E-1 | E-2 | E-3 | E-4 | E-5 | E-6 |
| F | F-1 | F-2 | F-3 | F-4 | F-5 | F-6 |

While any number of items can be selected and organized in different ways, the items shown can be arranged in a 6×6 matrix, six columns (1-6) by six rows (A-F), for purposes of illustration.

According to current display schemes, these items can be organized in what may be referred to as a 2-level hierarchical structure. A series of pop-up menus can be displayed at each level. For example, in order to display item “C-3” within the Group C group of items, the user may be presented with a typical 2-level hierarchical menu. First, the user can select Group C from among Groups A etc., on a first level menu (FIG. 1a or FIG. 1b). Second, the user can select the item “C-3” from among C-1 etc. on a second level menu (FIG. 1c) which is brought up by the selection of Group C within the first level menu.

The first level menu can be organized by following two approaches: Approach I (a vertical layout) or Approach II (a horizontal layout). The main drawback of Approach I is that typically one more additional click is required to dismiss the second level menu that brings the user back the first level menu in order to switch from a currently opened Group C to another one group such as Group A. Approach II is therefore often considered a better design choice since the user does not have to return back to the first level menu (e.g., navigation within Microsoft Word pull-down menus for groups of word processing functions such as File, Edit, View, Insert, Format, Tools, Table, Window etc.). The user can take advantage of only having to press vertical arrow keys (UP/DOWN) and pressing horizontal arrow key (LEFT/RIGHT) when switching between items within the same or different groups.

### BRIEF DESCRIPTION OF THE DRAWINGS

FIGS. 1a-1c describe various two level menu layouts.

FIG. 2 describes a user interface with a rotational or wraparound menu embodying a combination of the first level and the second level menus.

FIG. 3 describes a mobile telephone with multiple selection keys.

FIG. 4 illustrates various components of a user interface provided in accordance with the invention for a mobile telephone or handset.

FIG. 5a provides a matrix illustration or topographical map of where and how a user can navigate among an arrangement of items. FIG. 5b illustrates another embodiment of the invention that provides a user interface with two select keys, each identified with select key indicators LSK and RSK.

FIG. 6 describes a user device interface with multiple selection keys corresponding to a segmented cursor.

FIG. 7 illustrates another embodiment of the invention that provides a vertically oriented user interface and segmented cursor.

FIG. 8 illustrates a user interface with segmented cursors for navigation and selection of items arranged in a spreadsheet format.

FIG. 9 illustrates another embodiment of the invention that provides a user interface with segmented cursors that are visually mapped to select keys.

FIG. 10 illustrates another embodiment of the invention that provides a user interface with a display portion, a select button portion and a navigation portion.

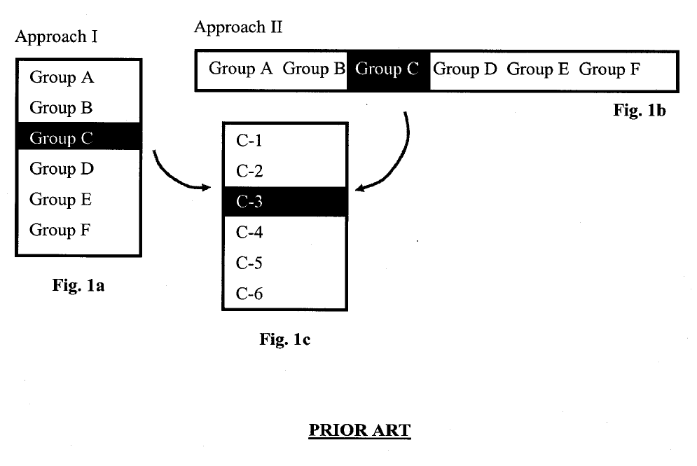

### DETAILED DESCRIPTION OF INVENTION

The invention provides methods and apparatus for navigating and selecting multiple items within a user interface. Various aspects of the invention described herein may be applied to any of the particular applications set forth below or for any other types of information that is displayed for viewing. The invention may be applied as a standalone tool or as part of an integrated software solution. It shall be understood that different aspects of the invention can be appreciated individually, collectively or in combination with each other.

An aspect of the invention provides methods and systems for navigating within a user interface with rotational or wraparound menus to display items within different groupings.

Another aspect of the invention provides a user interface having a graphical rounded positioning locator. The locator can be designed to resemble a compass with indicia (e.g., Group A) so as to provide the user with a location within an arrangement of items. The indicia can include rounded lettering having a curvature that may imply or suggest the rotational or wraparound menu features provided in accordance with another aspect of the invention.

With respect to yet another aspect of the invention, a user interface may include segmented cursors or pointers with multiple select keys that provide a plurality of items to choose from within the display without further navigation on the part of the user. As with other aspects of the invention, it shall be understood that items can be any kind of alphabetical and/or numerical information such as contact information with names and addresses, or any other kind of data including television programming within a viewing guide and what can be displayed within (Microsoft Excel) spreadsheets.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### Navigation Keys/Control

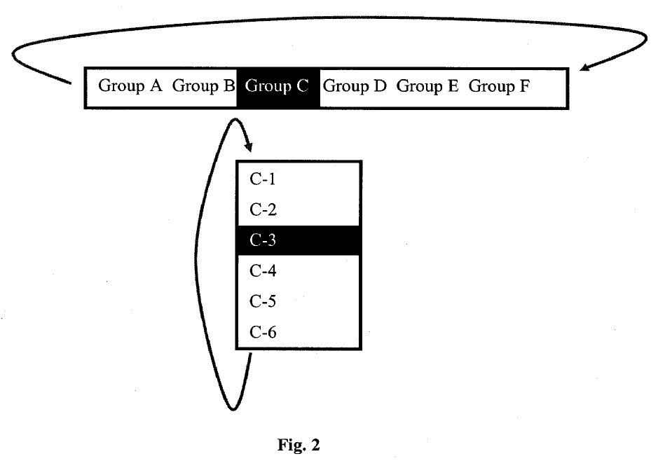

In a preferable embodiment of the invention, a user may navigate within the user interface with an arrangement of arrow and selection keys or an input device. For example, the arrangement may include five (5) keys: an Up arrow, a Down arrow, a Left arrow, a Right arrow and Select key (as shown elsewhere herein). The group of 36 items can be divided into 6 groups (A, B, C, D, E, F) each containing 6 items (1-6). A user can navigate to and select from different items within the table shown below (A-1, A-2 . . . F-5, F-6) using a combination of the navigation controls and/or selection keys provided in accordance with other aspects of the invention. The user may navigate among the plurality of items for viewing and/or selection by pressing the arrow keys. For example, the wraparound navigational keys provided in accordance with a preferable embodiment of the invention allow the user to continuously scroll within or between entire groups without interruption. When navigating between groups, the user may press either the Left or Right arrow keys just once or hold either down continuously such that Group A can be displayed again and selected after Group F. When navigating within a group such as Group C as shown below in FIG. 2, the user may press either the Up or Down arrow keys just once or hold either down continuously such that item C-1 can be displayed again and selected after item C-6. When an end point or limit of a group is reached, the wraparound menus provide herein can cycle or circle back to the other end point or limit within a group. Moreover, when the user navigates to item C-3 as shown below by using the Up or Down arrow keys, it would be possible to navigate or jump between groups to select corresponding items within other groups such as A-3, B-3, D-3, E-3 and F-3 by just pressing the Left or Right arrow keys. This aspect of the invention provides user interface that may be considered to be a rotational or wraparound menu embodying a combination of the first level and the second level menus provided in current display schemes.

### Menus Provided in Current Display Schemes.

The wraparound menus provided in accordance with this aspect of the invention can be applied to a variety of devices having a user interface. A user can navigate among a plurality of items within the interface by utilizing a variety of the directional and select keys including those described below. It shall be understood that these and other aspects of the invention can be applied to devices having limited input keys including portable or mobile devices such as remote controls for electronic equipment such as TVs or cable boxes, portable media players, handheld devices, personal digital assistants (PDAs) and mobile telephones or communications devices.

### Multiple Select Keys

Another aspect of the invention provides user interfaces having multiple select keys that are visually mapped to corresponding selectable items. Rather than displaying only a single item for user selection, a series of one or more items can be selected by the user by pressing one or more corresponding select keys.

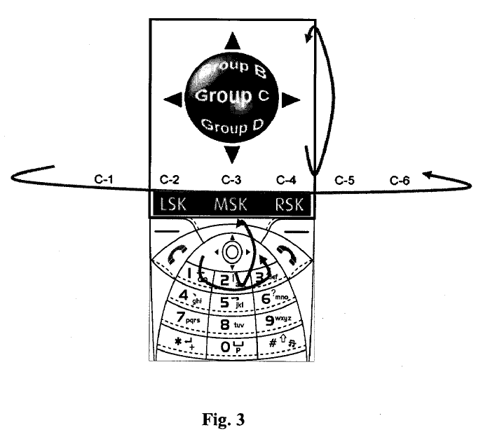

FIG. 3 describes a preferable embodiment of the invention that provides a mobile telephone with multiple selection keys. With the assistance of a visually mapped graphical user interface as shown below, a user can navigate within a selection of items arranged in multiple groups. Navigation controls including those provided in accordance with other aspects of the invention may be used to move between and within groups of items. For example, a mobile handset may include a set of arrow keys and a round positioning locator as shown in FIG. 3 (Up, Down, Left, Right arrows around a circular locator display identifying a particular group). The user may use the navigation controls to select Group C by pressing the Up/Down and/or Left/Right arrow keys of a joystick or thumb pointer as shown. A group portion of the positioning locator may display which Group C is being viewed, while an item portion may display a range of particular items within Group C. The range of items within Group C as shown include selectable items C-2, C-3 and C-4. The user may scroll to other items or item ranges within Group C by using the Left/Right arrow keys of the pointer. The wraparound menus provided in accordance with other aspects of the invention may be selected to continuously view and scroll to items within a group or between groups when the first or last item or group is reached.

Each selectable item within the user interfaces provided herein may have a corresponding select key. Multiple selection keys that can be visually mapped to selectable items provide a greater range of choices to the user while navigating among items contained or stored within the memory of the device (e.g., contacts or address lists). The physical locality and placement of the select keys in proximity to corresponding selectable items can provide an intuitive way for the user to make a selection among a multiple number of possible selections. For example, as shown in FIG. 3, a select key indicator for a left select key (LSK) can be displayed that corresponds to selectable item C-2, a middle select key indicator (MSK) can be displayed that corresponds to selectable item C-3, and a right select key indicator (RSK) can be displayed that corresponds to selectable item C-4.

The user interface in FIG. 3 may further include a graphical rounded positioning locator as with other embodiments of the invention provided herein. The locator can be designed to resemble a compass with indicia (e.g., Group C) as to provide the user with a location within an arrangement of items. The indicia can include rounded lettering having a curvature that may imply or suggest the rotational or wraparound menu features provided in accordance with another aspect of the invention.

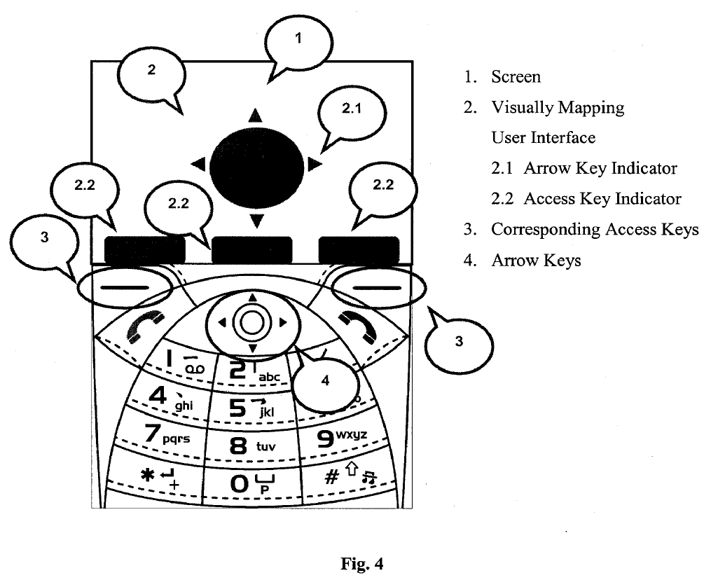

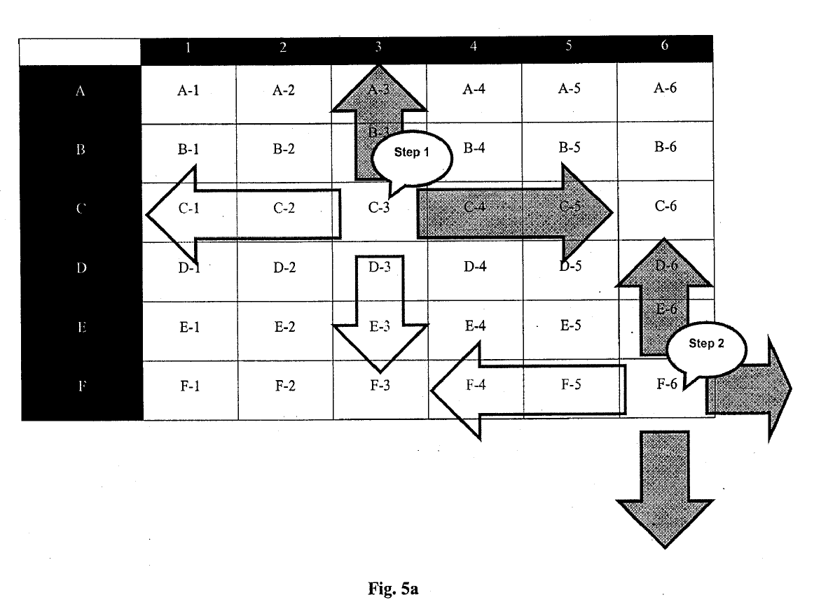

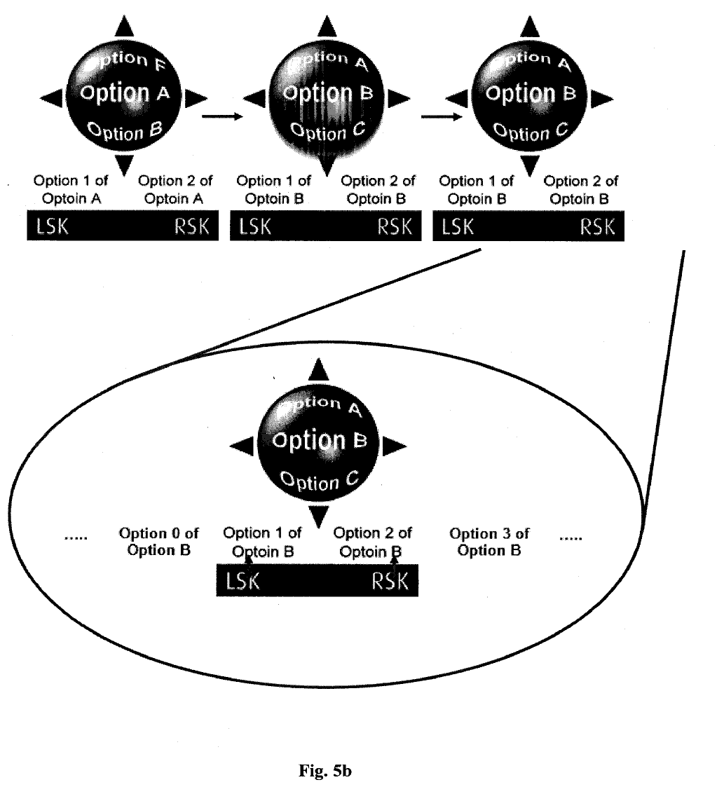

FIG. 4 illustrates various components of a user interface provided in accordance with another aspect of the invention for a mobile telephone or handset. It shall be understood however that these and other user interfaces provided herein may be implemented on a variety of portable electronic devices with navigation controls. The device may include a screen (1) on which the visually mapped user interfaces (2) provided herein can be rendered. The user interfaces may include a variety of indicators or graphical illustrations including a series of letters, numbers and symbols. A series of arrow key indicators (2.1) may be displayed and illuminate, flash or otherwise indicate direction and when the user is using navigation controls or pressing arrow keys (4). At the same time, a series of access key indicators (2.2) can display ranges of selectable items from which the user can choose from while navigating or scrolling through various items. When a desired item falls within a viewable range of the access key indicators (2.2), the user may select the desired item by pressing an access (select) key from a plurality of access keys (3) corresponding to the desired item. The proximity and location of the access key relative to the access key indicator intuitively communicates to the user which access key may be pressed. Unlike conventional user interfaces for handsets, a range of items may be displayed at the same time for immediate selection. It is not necessary to navigate or direct a cursor or pointer to a precise location or position that would only allow the selection of a single item.

FIG. 5a provides a matrix illustration or topographical map of where and how a user can navigate among an arrangement of items. Two exemplary steps are illustrated in the matrix which incorporates the use of navigational arrow keys (Up, Down, Left, Right) and the display of visually mapped arrow key indicators while navigating among items within the matrix.

Step 1: Pressing the vertical arrow keys (UP/DOWN) to select Group C, and then pressing horizontal arrow keys (LEFT/RIGHT) to navigate among items C-1, C-2, C-3, C-4, C-5, C-6 within Group C.

Step 2: Pressing vertical arrow keys (UP/DOWN) to navigate among Groups A to F, and selecting Group F, and then pressing horizontal arrow keys (LEFT/RIGHT) to navigate among items F-1, F-2, F-3, F-4, F-5, F-6 within Group F.

Items within each group may be displayed and selected or accessed by scrolling through and between the groups with navigational controls. When a desired item falls within a range of selectable items as displayed within the access key indicators, the user may press the corresponding select or access key that is visually mapped to the desired item.

For example, FIG. 5b illustrates another embodiment of the invention that provides a user interface with two select keys, which are each identified with select key indicators LSK and RSK as shown. In addition to providing intuitive navigation interfaces to a user, with assistance of the corresponding access keys (LSK, RSK) as illustrated, a variety of functional options within various groups can displayed and selected. For example, starting from Option A, a user can be offered two options for immediate and direct selection, Option 1 (A-1) or Option 2 (A-2). By using navigational controls as described elsewhere herein, the user can selection an option from a different set of options within Option B. By pressing a Down arrow key, the display can change to offer a new set of selections within the Option B group. Accordingly, Options 0, 1, 2, 3 . . . within Option B can be accessed directly by pressing corresponding access keys (LSK, RSK) to access displayed items or select displayed options directly. It shall be understood that as with other embodiments of the invention described herein, the select key indicators (LSK, MSK, RSK) can be graphical or visual depictions displayed on a screen or they can be actual hard keys or soft keys (touch screen applications).

Other aspects of the invention provide graphical user interfaces with segmented cursors. The segmented cursors can include highlighted or outlined display indicia or symbols within a display screen. They can serve as a reference point allowing the user to identify and view selectable items stored in memory or transmitted on a computing device. These cursors can be moved among the items with the user interface, or respectively, the displayed items can shift and pass through a stationary segmented cursor for viewing. Navigation keys and controls can be used including those described elsewhere herein such as a joystick, thumb dial or nub or mouse. Unlike conventional pointers such as an arrow, I-beam or blinking underline character which allow the selection of just one single item at a given time, the segmented cursors herein provide a range of selectable items that can be chosen. It shall be understood that the term cursor or pointer can be used interchangeably herein for purposes of describing the invention.

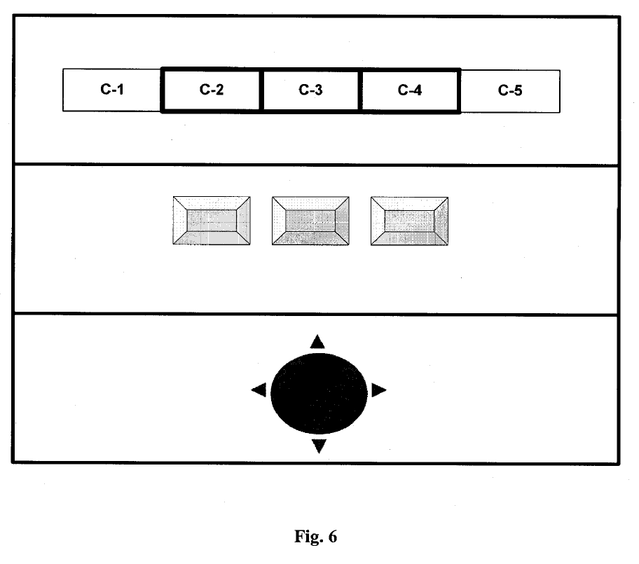

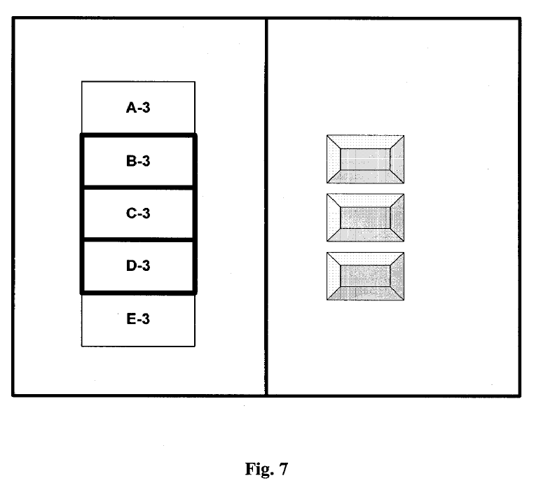

For example, FIG. 6 describes a preferable embodiment of the invention that provides a user device interface with multiple selection keys corresponding to a segmented cursor. The user may navigate within the user interface with navigation keys and directional controls that are incorporated into the device as described elsewhere herein. These include directional arrow keys or a central directional pad for thumb navigation, e.g., Samsung Blackjack, Palm Treo, Blackberry devices. In addition, the device includes a plurality of select keys that are visually mapped to the segmented cursor. There is preferably a 1:1 mapping of select keys to the number of segments within the segmented cursor. For example, three select keys can be positioned in proximity to a display so that each key corresponds to a segment within the cursor to allow for a range of selectable items as illustrated. Among a plurality of items show in the display of the device (C-1 to C-5), three selectable items (C-2 to C-4) are available to the user for immediate selection without requiring further navigation. To select item C-2, the user would press the visually mapped left side key. To select item C-3, the visually mapped center key would be pressed. To select C-4, the visually mapped right side key would be pressed. Accordingly, the segmented cursor and multiple selection keys can offer a range of selectable items that can be highlighted instead of just one item.

FIG. 7 illustrates another preferable embodiment of the invention that provides a vertically oriented user interface and segmented cursor. A display may be provided on a left side portion of the device to display a plurality of items to the user. The items may be arranged in a column (A-3 to E-3). The segmented cursor may include three segments stacked vertically with respect to each other. Each segment within the cursor may be highlighted with darkened borders. The right side portion of the device may include a plurality of visually mapped select keys. Each select key can correspond to a selectable item highlighted within the segmented cursor. The top key may be pressed to select item B-3, the middle key corresponds to C-3, and the bottom key can be selected by the user for item D-3. As with other embodiments of the invention, an item (e.g., C-3) may still be selectable even when the user navigates or scrolls to another portion of the display. A range of selectable items can be thus provided vertically when displayed to the user in accordance with this embodiment of the invention.

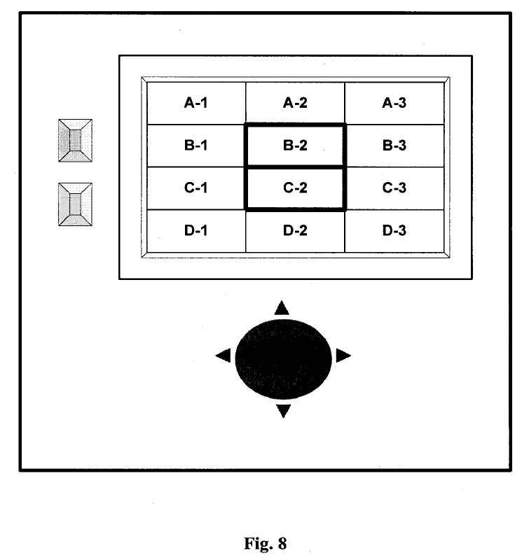

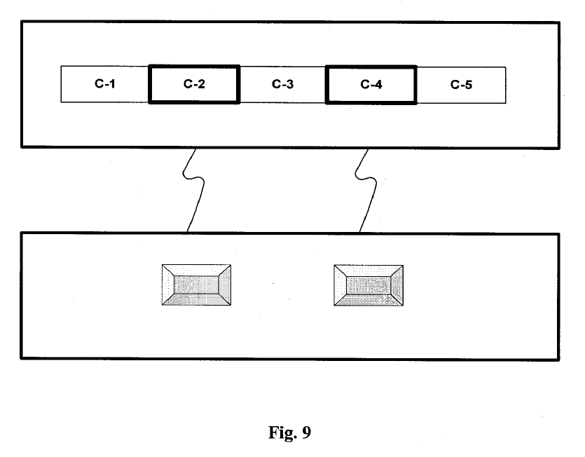

Another embodiment of the invention as shown in FIG. 8 provides a user interface with segmented cursors for navigation and selection of items arranged in a spreadsheet format. (e.g., Microsoft Excel). A device such as a personal computer (PC) or pocket PC or PDA can include a navigation control with directional keys, a screen display for displaying a group of items, and a set of selection keys. In this embodiment of the invention, the interface includes two select keys corresponding to two segments of a segmented cursor. The select keys are vertically oriented and visually mapped to the segmented cursor portions which can be highlighted to indicate what items or cells are selectable to the user. For example, items in column #2 are selectable as shown, namely B-2 and C-2. The directional keys may be pressed in any direction to navigate within the spreadsheet. By pressing a right arrow key once, the cursor may move over to the next adjacent column #3 so that items B-3 and C-3 may be selected by pressing the visually mapped select key located on the left side of the screen. As with other embodiments of the invention, by pressing the up arrow key once, the segmented cursor would move up and offer a selection of items A-2 and B-2. A common item can still be selected even when the cursor is moved to another portion of the screen since the invention can provide a range of selectable items at given time rather than just one particular selection. The devices configured in accordance with this aspect of the invention may be used as stand alone apparatus or as an input device or peripheral that can be connected to personal desktop or portable computer system.

Other embodiments of the invention provide user interfaces with segmented cursors that are visually mapped to select keys which are not in close proximity. For certain wireless devices, including remote controls, a screen, monitor or TV can be decoupled from an input device with multiple select keys. While there can still remain a 1:1 ratio of select keys to portions of a segmented cursor, the display and the select key portions are not required to be in close physical proximity to each other. The display may show the range of selectable items available to the user who may then enter a selection by pressing corresponding buttons on a remote control. A preferable embodiment of the invention can be adapted for TV or cable programming wherein the view scrolls through a guide on-screen. The segmented cursors provided in accordance with this aspect of the invention allow the user to select more than one program or item displayed on the screen at a given time.

For example, as illustrated in FIG. 9, multiple items (C-2 and C-4) displayed within a screen can be selected by a user by pressing corresponding keys on a wireless input device such as a remote control. Each select key can correspond to a portion or segment of a segmented cursor highlighted on the screen. A relatively left key can be pressed to select a marked item on the left side of the screen, or a relatively right key can be pressed to select a marked item on the right side of the screen. More than just one displayed selection can be made such that the user is not required to navigate precisely on just one show. Moreover, the segmented cursor allows the selection of non-consecutive or non-adjacent items or programming. Preferable embodiments of the invention may thus provide split segmented cursors that allow a range of non-consecutive displayed items that may reside anywhere in the screen. Each segment or portion of the split segmented cursor may correspond to a visually mapped select key that resides in an input device in relatively close proximity to a device display (or integrated as a single piece), or alternatively, in a spaced apart or wireless relation as illustrated. It shall be understood that any of the embodiments of the invention provided herein can be modified to incorporate split segmented cursors that allow the selection of spaced apart items within arrays or matrixes of items shown within a display.

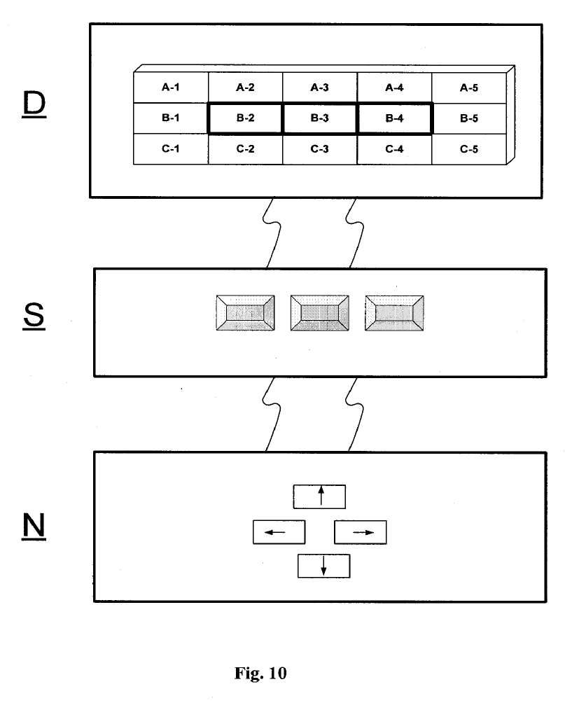

Another embodiment of the invention provides a user interface as shown in FIG. 10 that includes a display portion, a select button portion and a navigation portion. Each of these portions maybe integrally combined with a user device, or one or more portions may be decoupled as illustrated. The portions may communicate between each other wirelessly or via hardwiring as with other embodiments described herein. The navigation portion of the device may include a navigation button or control that effects movement of the cursor or pointer on a display screen. This may include a joystick, pointing stick or nub (IBM ThinkPad red nub), trackball, touchpad or directional arrow keys as illustrated. Alternatively, a mouse can be used move a pointer shown on the display portion of the device, which may contain at least one button and sometimes as many as three with different functions depending on what program is running. Some mouse devices include a scroll wheel for scrolling through long documents. These and other navigation controls can be incorporated into this and any other embodiment of the invention. Furthermore, the display portion may display a variety of items or selections available to the user. Using the navigation controls, the user can move a segmented and highlighted cursor around the display. A plurality of selectable items (B-2 to B-4) can be available at any given time for user selection rather than having to move the cursor to a precise location or one particular item. The select button portion of the device may include a select key corresponding to each segmented cursor portion. Accordingly, this aspect of the invention provides flexible user interfaces for electronic devices with segmented cursors simultaneously offering multiple selectable items.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for navigating within a user interface comprising the following steps of:
displaying a visual screen containing a range of selectable items from which a user can make a selection while navigating through a plurality of displayable items;
presenting a series of access key indicators corresponding to each item within the range of selectable items displayed on the visual screen; and
providing a plurality of access keys for accessing any item within the range of selectable items, wherein each access key is visually mapped to a corresponding access key indicator suggesting to the user which access key may be pressed for each selectable item.

2. A computer system with a user interface comprising:
a processor; and a computer readable medium coupled to the processor that stores a computer program for displaying a user interface, the computer program comprising a set of instructions for carrying out the method as recited in claim 1.

3. A portable electronic device with a user interface comprising:
a processor; and a computer readable medium coupled to the processor that stores a computer program for displaying a user interface, the computer program comprising a set of instructions for carrying out the method as recited in claim 1.

4. A computer program product bearing machine readable instructions to carry out the method for navigating within a user interface as recited in claim 1.

5. A computer readable medium having program code thereon for presenting a user interface, the program code causing a machine to perform the steps as recited in claim 1.

6. A computer system having a computer readable medium that stores a computer program with machine readable instructions for carrying out the method for navigating within a user interface as recited in claim 1.

7. A navigational user interface for an electronic device comprising:
a visual screen for displaying a range of selectable items from which a user can make a selection while navigating through a plurality of displayable items;
a series of access key indicators corresponding to each item within the range of selectable items displayed on the visual screen; and
a plurality of access keys for accessing any item within the range of selectable items, wherein each access key is visually mapped to a corresponding access key indicator suggesting to the user which access key may be pressed for each selectable item.

8. The user interface as recited in claim 7, wherein the electronic device is a mobile telephone.

9. The user interface as recited in claim 8, wherein the plurality of displayable items are personal contacts, and wherein the range of selectable items include telephone contact information for multiple individuals that may be accessed by user selection of the corresponding visually mapped access key.

10. The user interface as recited in claim 7, wherein the electronic device is a PC or personal computing device.

11. The user interface as recited in claim 10, wherein the plurality of displayable items is data contained within a spreadsheet, and wherein the range of selectable items includes a row of cells within the spreadsheet that may be accessed by user selection of the corresponding visually mapped access key.

12. A mobile handset interface comprising:
a visual display for displaying a plurality of selectable items;
a set of navigational arrow keys for directing movement of a segmented cursor relative to the plurality of selectable items, wherein the segmented cursor includes a plurality of segmented portions corresponding to each selectable item; and
a plurality of selection keys graphically mapped to each segmented portion of the segmented cursor corresponding to each selectable item.

13. The mobile handset as recited in claim 12, further comprising a positioning locator for indicating to which group the selectable items correspond.

14. The mobile handset as recited in claim 13, wherein the positioning locators is shaped with a compass like graphical illustration.

15. The mobile handset as recited in claim 12, wherein the plurality of selection keys includes a left select key (LSK), a middle select key indicator (MSK) and a right select key indicator (RSK) that each corresponds a selectable item displayed in the visual display.
